(19) United States
(12) Patent Application Publication
(10) Pub. No.: US 2013/0179260 A1
(43) Pub. Date: Jul. 11, 2013

(54) Predicting Trends Using A Geographic Position System

(71) Applicants: Susann M. Keohane, Austin, TX (US); Gerald F. McBrearty, Austin, TX (US); Shawn P. Mullen, Buda, TX (US); Jessica C. Murillo, Round Rock, TX (US); Johnny M. Shieh, Austin, TX (US)

(72) Inventors: Susann M. Keohane, Austin, TX (US); Gerald F. McBrearty, Austin, TX (US); Shawn P. Mullen, Buda, TX (US); Jessica C. Murillo, Round Rock, TX (US); Johnny M. Shieh, Austin, TX (US)

(73) Assignee: International Business Machines Corporation, Armonk, NY (US)

(21) Appl. No.: 13/345,850

(22) Filed: Jan. 9, 2012

(51) Int. Cl. G06Q 30/02; G06F 15/18; G06Q 30/06

(52) U.S. Cl. 705/14.53; 705/26.1; 706/12

(57) ABSTRACT

Embodiments of the invention relate to dynamic assessment of a prior purchase pattern to predict a future purchase. The prior purchase pattern is tracked and mapped to a geographic position system. Based upon a current physical location or a known future location, both a future purchase and purchase location are ascertained and communicated to a mobile device in communication with the geographic position system.

### BACKGROUND

1. Technical Field

The present invention relates to a method and system for integration of a geographic position system with product purchasing patterns. More specifically, the invention relates to a system and method that combines information gathered by the geographic position system with historical purchase pattern data to return a comparable offer for a product or service.

2. Description of the Prior Art

A geographic position system, hereinafter referred to as a GPS, is a space-based global navigation satellite system that provides location and time information. Specifically, the GPS is a satellite navigation system used to determine ground position and velocity (location, speed, and direction). Though it was created and originally used by the U.S. military, GPS is now available to the general public all over the world. GPS navigation systems are currently installed in vehicles, complete with a visual display map that shows the exact location of the vehicle. Advanced vehicle GPS receivers include voice activated controls that enables a vehicle operation to provide verbal directions to a certain destination.

### SUMMARY OF THE INVENTION

This invention comprises a method, system, and apparatus for predicting behavioral trends through a GPS receiver.

In one aspect of the invention, a method is provided for leveraging the functionality of the GPS to assessing behavioral patterns. More specifically, purchase patterns are tracked by way of a telecommunication device. The purchase patterns include data such as product category and/or calendar data. Each of the tracked purchase patterns are mapped to a GPS. One or more of the purchases patterns are studied through the use of the telecommunication device, including each purchase within the purchase patterns attached to a geographic location. A future product purchase is predicted based upon the studied purchase pattern(s) and its associated geographic location.

In another aspect, a telecommunication device is provided with a processor in communication with memory. The telecommunication device is configured to support a purchase pattern assessment, and includes a functional unit in communication with the processor to support leveraging geographical position data. The functional unit includes a track manager, a map manager, and a set of instructions in communication with the memory. The track manager is configured to track purchase patterns associated with the device. The purchase patterns include product category data and/or calendar data. The map manager, which is in communication with the track manager, maps each of the tracked purchase patterns to a geographic position system. The set of instructions in communication with the memory support at least two tools, including a director and a prediction manager. The director functions to learn at least one purchase pattern. Each purchase within the purchase pattern is attached to a geographic location. The prediction manager functions to predict a future product purchase based upon the learned purchase pattern and an associated geographic location ascertained by the director. The associated geographic location includes a current geographical position data, or a route programmed into the geographic position system.

In yet another aspect, a computer program product is provided. The computer program product includes a computer-readable storage medium having computer readable program code embodied thereon, which when executed causes a computer to implement a method for leveraging the functionality of the GPS to assess behavioral patterns. Program code is provided to employ a telecommunication device to track purchase patterns, including product category data and/or calendar data. The program code maps the tracked purchase patterns to a geographic position system. Program code is also provided to learn at least one of the tracked purchase patterns. Each purchase within the tracked purchase patterns is attached to a geographic location. Program code is further provided to predict a future purchase. More specifically, the prediction is based upon the learned purchase pattern and an associated geographic location, wherein the associated geographic location data includes a current geographical position data or a route programmed into the geographic position system.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a flow chart illustrating a process for acquiring product purchase data in conjunction with the GPS.

FIG. 2 depicts a flow chart illustrating a process for dynamically predicting a purchase pattern based upon a non-programmed travel route.

FIG. 3 depicts a flow chart illustrating a process for utilizing the time and/or date information stored in memory with the prior purchase data.

FIG. 4 depicts a flow chart illustrating a process for leveraging the route guidance feature of the GPS for predicting a future purchase.

FIG. 5 depicts a flow chart illustrating a process for ascertaining both future product prediction and vehicle service data.

FIG. 6 depicts a block diagram illustrating tools embedded in a system to support an effective and intelligent manner of predicting one or more future behavioral patterns.

FIG. 7 depicts a flow chart illustrating a process for loading the log from storage and parsing the continuous log for one or more select threads.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, including managers and a director. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

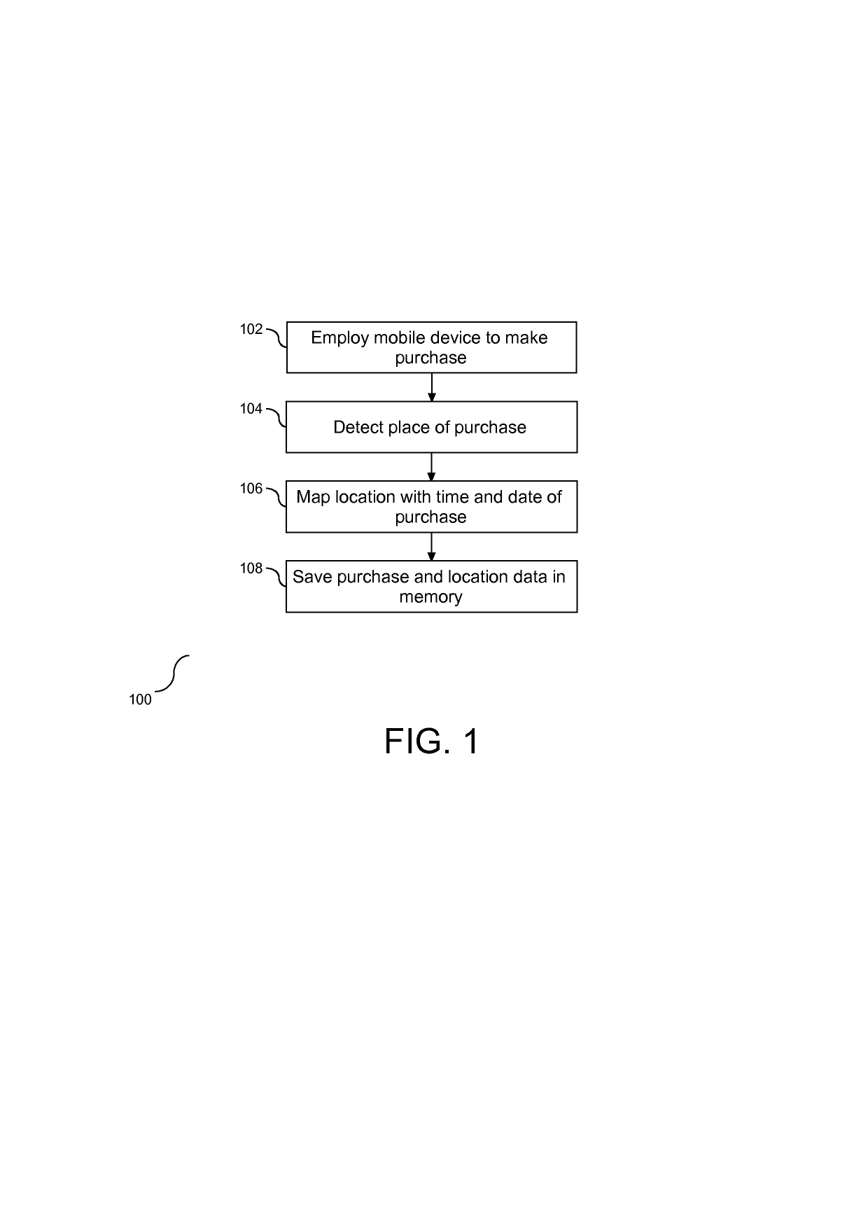

The art of utilizing a GPS to track travel and associated travel information can include various embodiments. The goal of utilizing the GPS is to leverage acquired data in an effort to predict future purchase(s) of products and/or services. Prior to predicting the future, data in the present must be acquired and retained. FIG. 1 is a flow chart (100) illustrating a process for acquiring purchase data in conjunction with the GPS. A mobile communication device is employed to purchase a product or service, or to request the purchase (102). In one embodiment, a credit card or debit card is employed to purchase a product or service, with the purchase synchronized to the mobile device. The synchronization between the credit or debit card may be in real-time or non-real-time. For example, a real-time synchronization may employ a secure mobile device application and authorization and agreement with the underlying credit card or debit card company. In another embodiment, data associated with the purchase of the product or service may be manually entered into the mobile device. Accordingly, as demonstrated herein there is a plurality of tools and associated methods for communicating purchase data with the mobile device, wherein the purchase may or may not be initiated and/or completed with the mobile device.

Following the purchase or purchased synchronization, the place where the purchase took place or is in the process of taking place is detected (104). The location information at step (104) is obtained by the GPS, a tower triangulation algorithm, etc. Once the location of the purchase has been detected, the location is mapped together with the time and date of the purchase (106), and the location, product or service, time and date are saved in memory (108). In one embodiment, the memory is local to the telecommunication device. Similarly, in one embodiment the memory is stored remote from the telecommunication device. Accordingly, the purchase and associated data is acquired and retained.

One aspect of retaining the product purchase data is to utilize it to predict future behavior. A set of instructions are provided in communication with the saved data, with the instructions configured to learn one or more purchase patterns attached to a geographic location (110). By learning one or more past behavior purchase patterns, a future purchase may be predicted. Accordingly, the GPS is utilized to associated location data with purchase data for future product purchase prediction.

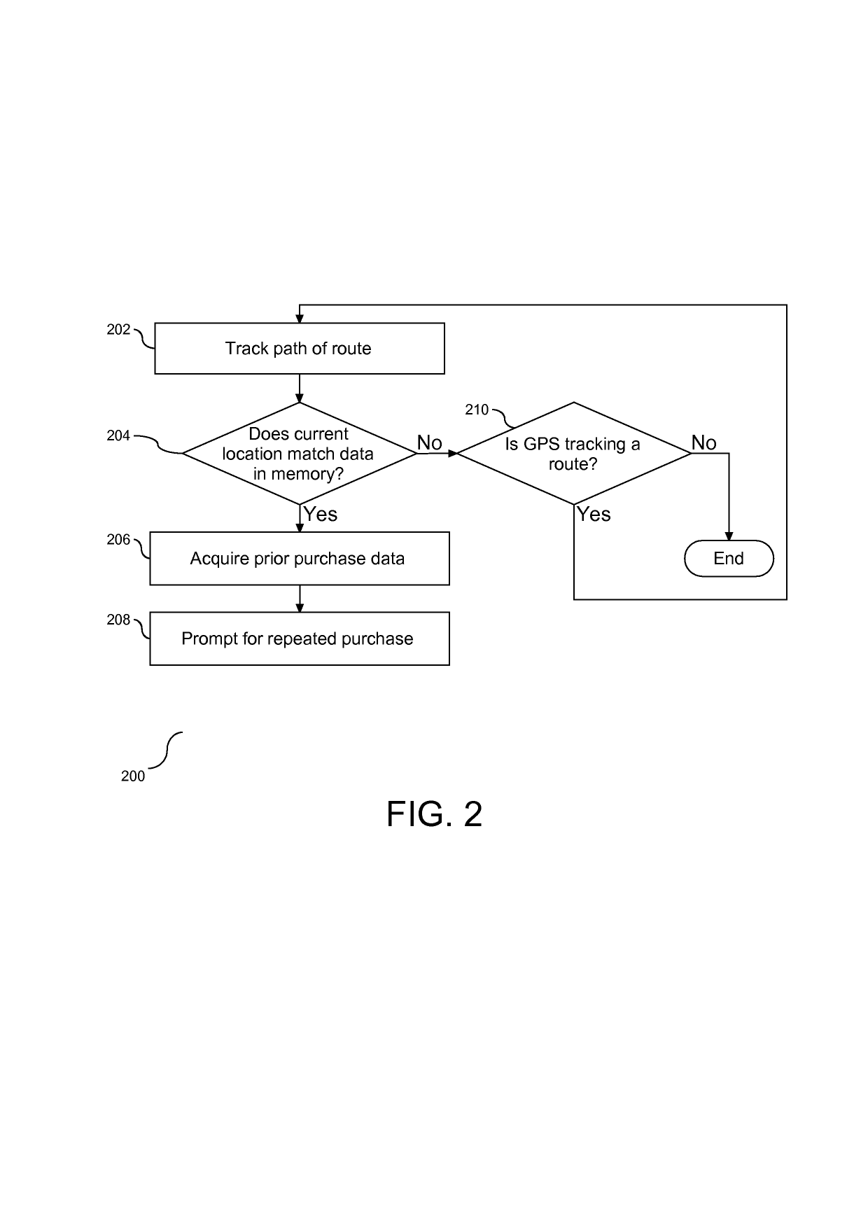

Since the purchase data is associated with GPS data; the future purchase prediction may be implemented in a dynamic manner. FIG. 2 is a flow chart (200) illustrating a process for dynamically predicting a purchase pattern based upon a non-programmed travel route. A GPS device is employed to track the path of the route (202). As the GPS tracks the current route, the GPS dynamically determines if there is a match between any location saved in memory with a prior purchase and any current route location (204). A positive response to the determination at step (204) is followed by acquiring prior purchase data at the subject location (206). Thereafter, a communication is sent to the mobile device in communication with the GPS with a prompt for a repeated purchase (208). More specifically, at step (208) the mobile device is told about a prior purchase at the subject location on the current route in order to assess if a person in communication with the mobile device wants to revisit the subject location for a repeat purchase. However, following a negative response to the determination at step (204), it is determined if the GPS device is tracking a route (210). More specifically, at step (210) it is determined if the GPS is continuing to track any current travel movement. A positive response to the determination at step (210) is followed by a return to step (202), and a negative response to the determination at step (210) concludes the tracking process. Accordingly, a GPS tracked movement may utilize the prior purchase patterns stored in memory.

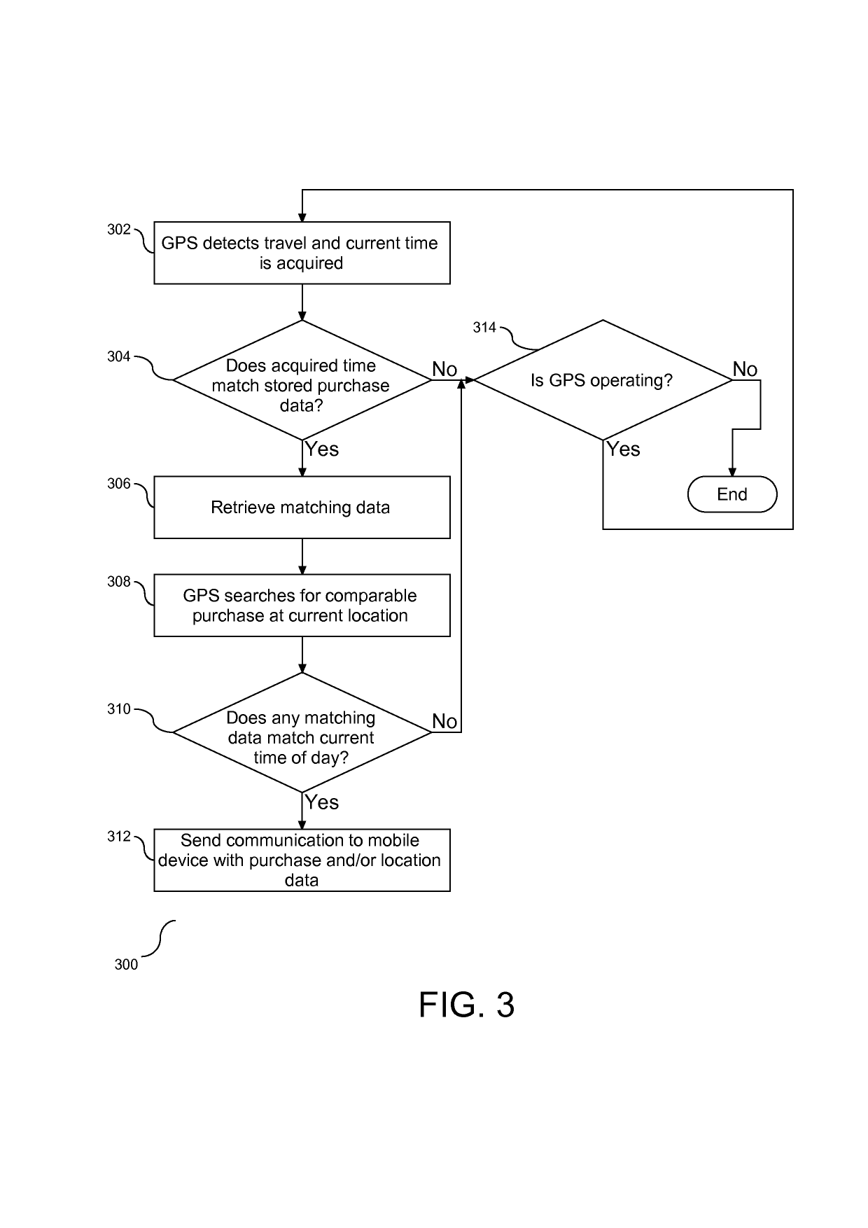

As shown and described above, once one or more prior purchase patterns are known and studied, they may be utilized to assess a current position detected by the GPS with a prior purchase. In another embodiment, data associated with the purchase may be utilized for a future purchase. More specifically, both time of purchase and date of purchase are stored in memory together with the product and location data. FIG. 3 is a flow chart (300) illustrating a process for utilizing the time and/or date information stored in memory with the prior purchase data. At such time as the GPS detects travel movement, the current time is acquired (302). It is then determined if the time matches any of the time data stored in memory with any of the stored prior purchase data (304). A positive response to the determination at step (304) is followed by retrieving the associated purchase data stored in memory that matches the acquired time (306). The GPS device then searches for a comparable purchase at the current GPS location (308). Accordingly, the prior purchase data is searched in real-time with current time data.

Following step (308), it is determined if any purchase data was previously tracked and stored based upon the current time data, e.g. time of day (310). A positive response to the determination at step (310) is following by sending a communication to the mobile device with associated purchase and/or location data (312). The communication may be in the form of a voice based or text based communication. In one embodiment, the message may provide instructions for a repeated purchase. A negative response to the determination at either step (304) or step (310) is followed by determining if the GPS is continuing to operate (314). If the response to the determination at step (314) is positive, the process returns to step (302). However, if the response to the determination at step (314) is negative, the detection and communication process concludes. Accordingly, the GPS may be utilized to track prior purchases based upon time as long as the GPS remains in an operational mode.

The processes outlined in FIGS. 2 and 3 utilize tracked purchases and associated data, also referred to as metadata, to predict a future purchase. In one embodiment, the process outlined in FIG. 1 works in the background to acquire new data as purchases take place. For example, for a new purchase that takes place in response to the tracking in either FIG. 2 or 3, associated new purchase data and metadata is saved in memory. When the GPS is an active state, a purchase can be predicted base upon metadata associated with the stored purchase data. In one embodiment, the GPS merely tracks the location as the location changes, and at the same time predicts a future purchase. Accordingly, the GPS may be utilized to track current movement and predict a future purchase in real-time.

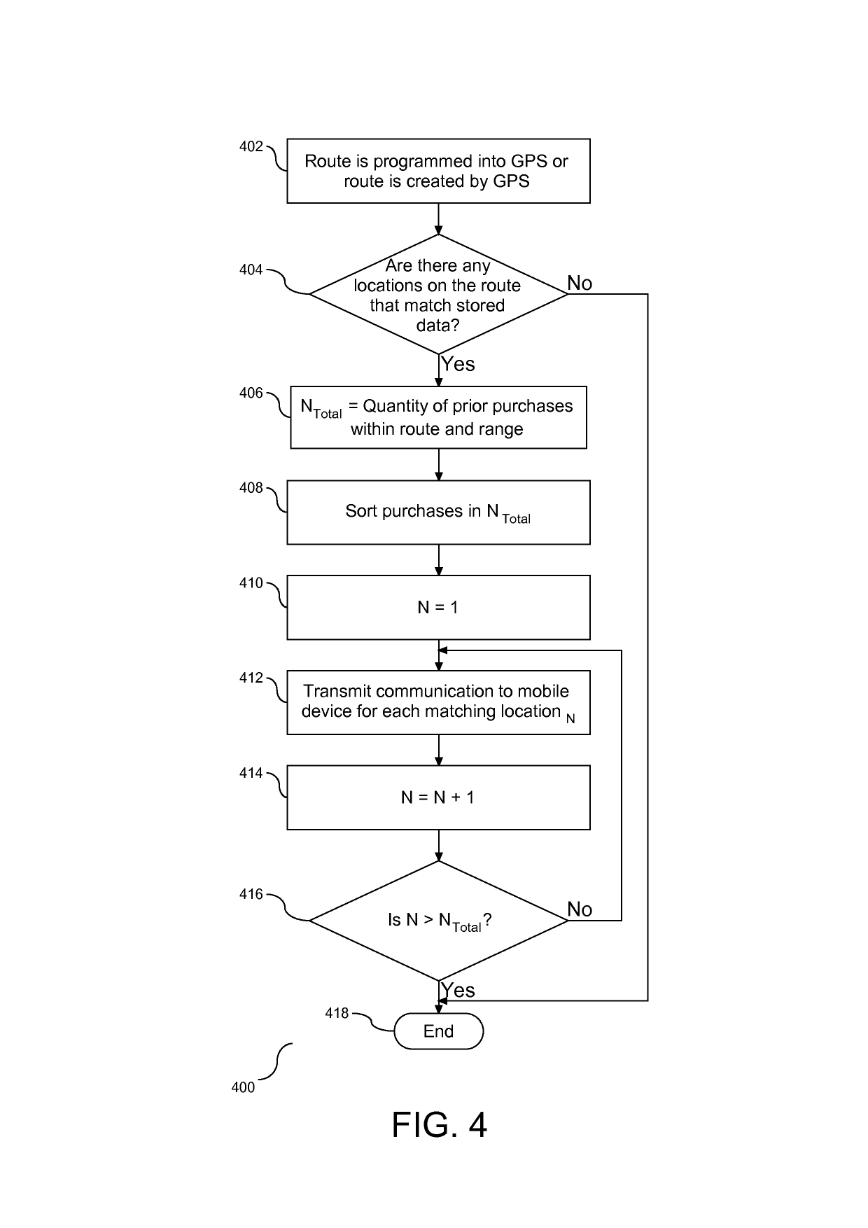

It is know that a GPS device can be programmed to provide directions to a destination location. The user may enter the destination location, and the GPS will provide one or more routes that the user may select. FIG. 4 is a flow chart (400) illustrating a process for leveraging the route guidance feature of the GPS for predicting a future purchase. As shown, a route is either programmed into the GPS device or the route is created by the GPS device based upon a destination location (402). Because the route is known, this knowledge may be leveraged with respect to one or more future purchases. Following step (402), it is determined if there are any geographical locations on the route that match the stored data of one or more prior purchases (404). In one embodiment, a periphery variable may be employed to expand the geographical locations for a defined range with respect to the route. For example, in one embodiment, a geographical location may be within a one mile range of the route, or a five mile range of the route. By expanding the range of the geographical location, the probability of a matching location increases. Accordingly, the provision of a route together with an expansion range provides a known quantity about which a future purchase may be ascertained.

Following a negative response to the determination at step (404), the recommendation process is concluded (418). However, following a positive response to the determination at step (404), the variable N_{Total} is assigned to the quantity of prior purchases that fall within the programmed route and an associated expansion range (406). The prior purchases may be at one or more locations along the route. In one embodiment, since the route is known, the quantity as represented by N_{Total} is sorted based upon the starting and ending points of the route (408). An associated counting variable N is set to the integer one (410). At each location_{N} along the programmed route that matches with a prior purchase location, a communication is transmitted to an associated mobile device (412). In one embodiment, the communication includes data pertaining to the prior purchase and/or a prompt for a repeat purchase. Following step (412) the variable N is incremented (414), followed by a determination as to whether all of the identified and sorted locations have been evaluated (416). A positive response to the determination at step (416) concludes the evaluation process (418), whereas a negative response is followed by a return to step (412). Accordingly, with a route programmed into the GPS device together with a range, the subject locations may be identified and sorted to provide an organized approach for evaluating and predicting a future purchase.

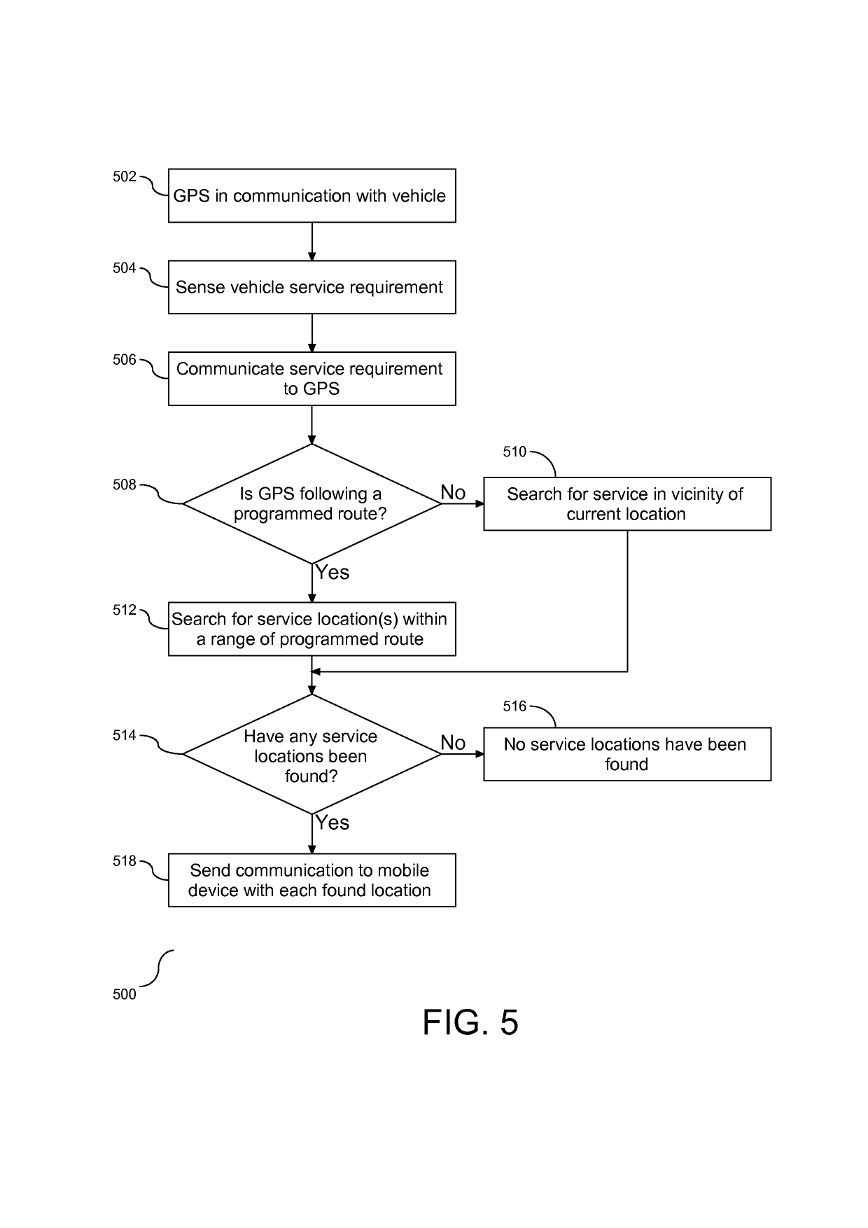

A GPS device comes in various forms. For example, the GPS device may be embedded within the mobile device. In one embodiment, the GPS device may be embedded within or otherwise attached to a vehicle, including but not limited to a land vehicle, an air vehicle, and a water vehicle, with the GPS device in communication with the mobile device. FIG. 5 is a flow chart (500) illustrating a process for ascertaining both future product prediction and vehicle service data. As shown, the GPS device is provided in communication with the vehicle (502). At such time as a service requirement for the vehicle is sensed (504), this service requirement is communicated to the GPS device (506) in an effort to ascertain a location to support the service requirement. In one embodiment, the ascertained location may be either in the current vicinity of the GPS device or along a programmed route. As such, it is determined if the GPS is in the process of following a programmed route (508). A negative response to the determination at step (508) is following by searching for a service location in a defined vicinity of the current location (510). Conversely, a positive response to the determined at step (508) is followed by searching for one or more service locations within a defined range of the programmed route (512). Accordingly, the GPS is leveraged to ascertain a service location to resolve the vehicle service requirement.

Following either step (510) or step (512), it is determined if any service locations have been found (514). A negative response to the determination at step (514) is followed by sending a communication to the mobile device with communication data indicating that no locations have been found (516). Conversely, a positive response to the determination at step (514) is followed by sending a communication to the mobile device with each found location (518). Accordingly, the location for provision of the service may be in response to a service requirement for a vehicle.

As described above, the GPS may be associated with a traveling vehicle or with a stationary object or vehicle. At the same time, prior purchase data is retained and leveraged to predict future purchase(s) of the same or similar products or services, and in one embodiment based upon time of purchase. In one embodiment, an advertisement is embedded in the system, and supports communication of an advertisement or an alert to the mobile device under select circumstances. For example, the advertisement may be communicated to the device based upon an advertisement source, such as a prior purchase location and a new purchase location. If the GPS is determined to be near a prior purchase location, the advertisement may be communicated to the mobile device. Similarly, if the GPS together with the purchase tracking algorithm determines a new purchase location, the advertisement may also be communicated to the mobile device. The advertisement aspect may be enabled under various circumstances, including but not limited to subject matter and location. Accordingly, the enabling aspect of the advertisement supports communication between vendors and consumers.

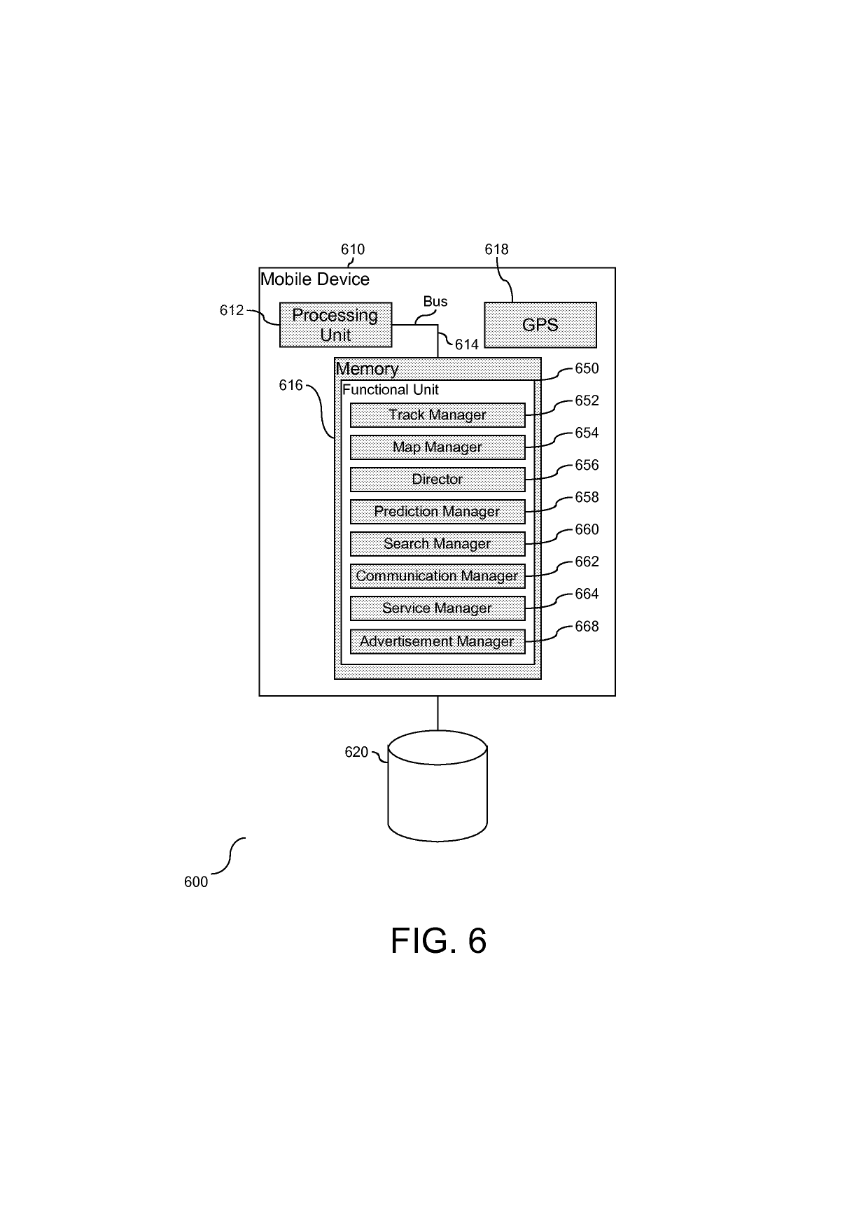

The leveraging of historical data together with the communication between the GPS and the mobile device provides an intelligent pattern assessment tool to predict future actions. FIG. 6 is a block diagram (600) illustrating tools embedded in a system to support an effective and intelligent manner of predicting one or more future behavioral patterns. For illustrative purposes, a mobile telecommunication device (610), hereinafter referred to as a mobile device, is provided with a processing unit (612) in communication with memory (616) across a bus (614). The mobile device (610) is in communication with a geographic position system (GPS) (618). In addition, the mobile device is in communication with data storage (620). As shown, the GPS (618) is local to the mobile device (610). In one embodiment, the GPS (618) maybe separate from the mobile device (610).

The mobile device (610) includes tools to support a purchase pattern assessment for a product, service, and a combination thereof. A functional unit (650) is provided in communication with the memory (616); the functional unit (650) supports the assessment. As shown, the functional unit (650) is provided with a track manager (652), a map manager (654), a director (656), a prediction manager (658), a search manager (660), a communication manager (662), a service manager (664), and an advertisement manager (668). The track manager (652) functions to track purchase patterns associated with the mobile device (610). More specifically, each purchase has data and the accumulation of this data over the course of multiple purchases forms a pattern reflective of behavior. Accordingly, the tools embedded in the functional unit support dynamic assessment of behavior patterns and enable real-time prediction of future behavior.

The track manager (652) functions to track purchase patterns associated with the mobile device (610). More specifically, the purchase patterns include, but are not limited to, product category and/or calendar data. The product category describes the subject and type of the product. The calendar data describes the date and time when the product was purchased. The map manager (654), which is in communication with the track manager (652), functions to map each of the tracked purchase patterns to a geographic position system. As shown, the mobile device (610) may include an embedded GPS (618), which would enable geographic location data to be associated directly with the product purchase. In one embodiment, the mobile device (610) may be in communication with the GPS (618) across a network connection. Accordingly, the GPS (618) is employed as a location tracking tool to address future behavior prediction associated with geographic elements.

A set of instructions are provided in communication with the memory (616). Specifically, the instructions support dynamic prediction of future behavior patterns. In one embodiment, the instructions are in the form of heuristic programming. At least two tools are employed by the instructions to support the functionality, including the director (656) and the prediction manager (658). The director (656) is configured to learn one or more purchase patterns. Each purchase within the purchase pattern is attached to a geographic location as ascertained by the GPS (618). The prediction manager (658) is configured to predict a future product purchase and location for the future purchase based upon at least one purchase pattern studied by the director (656). The location for the future purchase is determined relative to current position data or a travelling route programmed into the GPS (618). Accordingly, the GPS (618) is in communication with the tools to support future behavior assessment.

In addition to predicting future behaviors, the search manager (660) is provided in communication with the prediction manager (658) as a tool to support execution of the predicted behavior. More specifically, the search manager (660) seeks a comparable offering or a product (or service) at a new geographic location. If the director (656) has determined that a purchase of a specific product took place at a specific location, the search manager (660) looks for the same or similar product at a new location. For example, the tools may detect purchase patterns of coffee, including time of purchase and location, and from the pattern may suggest a future coffee purchase at a new location based upon time. One of the tools provided is a communication manager (662). More specifically, the communication manager (662) functions to send a communication to the mobile device (610) to inform the user of the device about a future product offering, suggested purchase, etc. The communication may be text or voice based, or a combination of text and voice. For example, the communication manager (662) may transmit a text based message to the mobile device. Accordingly, the search manager (660) functions together with the communication manager (662) to find a location and to communicate the location to the mobile device (610), respectively.

As described above, the tools may be employed for product purchase assessments in an effort to predict a future product purchase. However, the invention should not be limited to product assessment. In one embodiment, the assessment may be expanded to include services. For example, in one embodiment, the GPS (618) may be in communication with a vehicle, including but not limited to a land, air, or water vehicle. It is known and accepted that vehicles require servicing on a periodic basis in order to maintain a working condition thereof. A service manager (664) is provided in communication with the map manager (654). More specifically, the service manager (664) functions to sense a service requirement of the vehicle, and to communicate any service requirements to the communication manager (662) which then sends a communication to the mobile device (610) with a service location and associated geographic data. In one embodiment, the suggested service location may be the closest location, or the suggested service location may be a prior location used to service the vehicle as ascertained from the tracked purchase pattern. Accordingly, the behavioral tools may be applied to support service requirements.

Advertising is a form of communication that is commonly used to direct consumers to a vendor or group of vendors. The tools described herein may include an advertisement manager (668) in communication with the director (656). The advertisement manager (668) is configured to send an alert in the form of a voice or text based communication to the mobile device (610), with the alert based on context associated with an advertisement source including a prior purchase location or a new purchase location. Accordingly, the advertisement manager (668) functions to communicate with the mobile device based upon prior purchase patterns.

As identified above, the track manager (652), map manager (654), director (656), prediction manager (658), search manager (660), communication manager (662), service manager (664), and advertisement manager (668), hereinafter referred to as tools; function as elements to support dynamic assessment of behavior to support prediction of a future behavioral characteristic. The tools (652)-(668) are shown residing in memory (616) local to the mobile device (610). However, the tools (652)-(668) may reside as hardware tools external to memory (616), or they may be implemented as a combination of hardware and software. Similarly, in one embodiment, the tools (652)-(668) may be combined into a single functional item that incorporates the functionality of the separate items. As shown herein, each of the tools (652)-(668) are shown local to the communication device (610). However, in one embodiment they may be collectively or individually distributed across a network or multiple machines and function as a unit to evaluate hardware performance. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

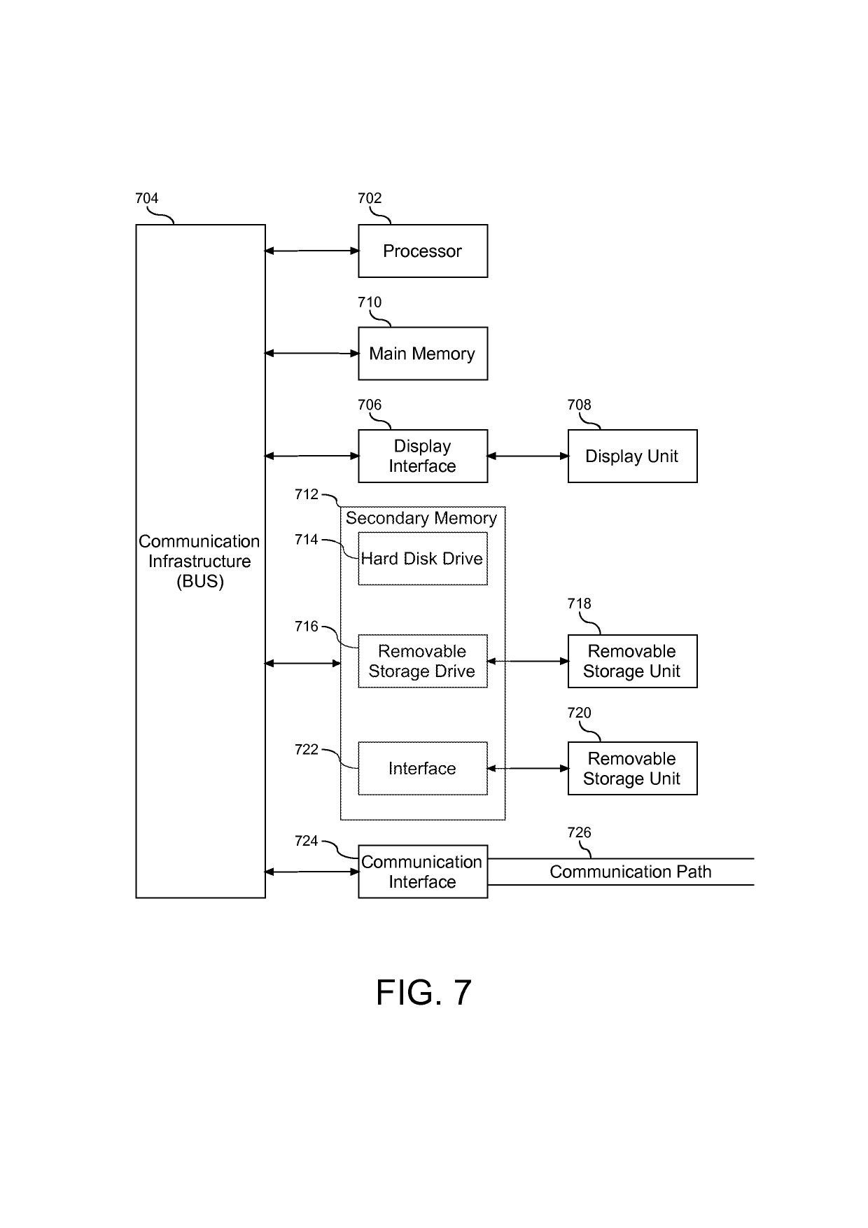

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Data associated with the purchase of products and/or services may be evaluated and/or sold. Specifically, the purchase data may be sold together with or separate from the route programmed into the geographic position system, and thereafter employed for business related decisions such as opening a new storefront location, closing an existing storefront location, etc. Accordingly, the scope of protection of this invention is limited only by the following claims and their equivalents.

We claim:

1. A method comprising:
tracking, by a telecommunication device, purchase patterns, wherein the purchase patterns include data selected from the group consisting of product category, calendar data, and combinations thereof;
mapping each of the tracked purchase patterns to a geographic position system;
learning at least one purchase pattern utilizing the telecommunication device, each purchase within the purchase patterns attached to a geographic location; and
predicting a future product purchase based upon the learned purchase pattern and an ascertained geographic location, wherein the ascertained geographic location is selected from the group consisting of: current geographical position data, and a route programmed into the geographic position system.

2. The method of claim 1, wherein the geographic positioning system includes an element selected from the group consisting of: a global positioning system, and a mobile communication device tower.

3. The method of claim 1, further comprising searching for a comparable product offering at a new geographic location based on the tracked purchase patterns.

4. The method of claim 3, further comprising sending a communication to a mobile device with the comparable product offering, wherein the communication is selected from the group consisting of: text and voice, and combinations thereof.

5. The method of claim 1, wherein the geographic position system is in communication with a land vehicle, and further comprising sensing a service requirement of the vehicle and sending a communication to a mobile device with at least one service location for the vehicle within a defined geographic range.

6. The method of claim 5, wherein the service location communication is selected from a prior purchase location ascertained from one of the tracked purchase pattern.

7. The method of claim 1, further comprising an advertisement in communication with the device, and sending an alert to the telecommunication device based on an advertisement source, wherein the advertisement source is selected from the group consisting of: a prior purchase location, and a new purchase location.

8. The method of claim 1, further comprising selling the purchase data, including the route programmed into the geographic position system.

9. A system comprising:
a telecommunication device having a processor in communication with memory, the telecommunication device to support a purchase pattern assessment:
a functional unit in communication with the processor, the functional unit comprising:
a track manager to track purchase patterns associated with the device, wherein the purchase patterns include data selected from the group consisting of: product category, calendar data, and combinations thereof;
a map manager in communication with the track manager, the map manager to map each of the tracked purchase patterns to a geographic position system;
a set of instructions in communication with the memory, the set of instructions comprising:
a director to learn at least one purchase pattern, each purchase within the purchase pattern attached to a geographic location; and
a prediction manager to predict a future product purchase based upon the learned purchase pattern and associated geographic location ascertained by the director, wherein the associated geographic location is selected from the group consisting of: current geographical position data, and a route programmed into the geographic position system.

10. The system of claim 9, further comprising a search manager to search for a comparable product offering at a new geographic location based on the tracked purchase patterns.

11. The system of claim 10, further comprising a communication manager to send a communication to a mobile device with the comparable product offering, wherein the communication is selected from the group consisting of: text, voice, and combinations thereof.

12. The system of claim 9, wherein the geographic position system is in communication with a land vehicle, and further comprising a service manager to sense a service requirement of the vehicle and send a communication to the telecommunication device with at least one service location for the vehicle within a defined geographic range.

13. The system of claim 12, wherein the service location communication is selected from a prior purchase location ascertained from the tracked purchase pattern.

14. The system of claim 9, further comprising an advertisement manager to send an alert to the telecommunication device based on context associated with an advertisement source, wherein the advertisement source is selected from the group consisting of: a prior purchase location, and a new purchase location.

15. A computer program product comprising a computer readable storage medium having computer readable program code embodied thereon, which when executed causes a computer to implement the method comprising:
tracking, by a telecommunication device, purchase patterns, wherein the purchase patterns include data selected from the group consisting of: product category, calendar data, and combinations thereof;
mapping the tracked purchase patterns to a geographic position system;
learning at least one of the tracked purchase patterns, each purchase within the tracked purchase patterns attached to a geographic location; and
predicting a future product purchase based upon the learned purchase pattern and associated geographic location, wherein the associated geographic location is selected from the group consisting of: current geographical position data, and a route programmed into the geographic position system.

16. The computer program product of claim 15, wherein the geographic positioning system includes an element selected from the group consisting of: a global positioning system, and a mobile communication device tower.

17. The computer program product of claim 15, further comprising searching for a comparable product offering at a new geographic location based on the tracked purchase patterns.

18. The computer program product of claim 17, further comprising sending a communication to a mobile device with the comparable product offering, wherein the communication is selected from the group consisting of: text and voice, and combinations thereof.

19. The computer program product of claim 15, wherein the geographic position system is in communication with a land vehicle, and further comprising sensing a service requirement of the vehicle and sending a communication to a mobile device with service locations for the vehicle within a defined geographic range.

20. The computer program product of claim 19, wherein the service location communication is selected from a prior purchase location ascertained from the tracked purchase patterns.
